(19) United States
(12) Patent Application Publication
(10) Pub. No.: US 2010/0183794 A1
(43) Pub. Date: Jul. 22, 2010

(54) Barbecue Sause

(76) Inventor: Corine P. Jackson, Lake Worth, FL (US)

Correspondence Address: Nicholas J. Aquilino, 1181 Palomino Pass, Bogart, GA, 30622, US

(21) Appl. No.: 12/592,954

(22) Filed: Dec. 7, 2009

Related U.S. Application Data
(60) Provisional application No. 61/146,341, filed on Jan. 22, 2009.

(51) Int. Cl. A23L 1/39; A23L 1/221; A23L 1/225

(52) U.S. Cl. 426/589

(57) ABSTRACT

A barbeque sauce made with a combination of commonly available ingredients that are mixed in a unique and flavorful combination suitable for marinating, basting, cooking or as a tasty spread for application to a wide variety of foods including but not limited to, beef, pork, chicken and similar foods. The ingredients include sweeteners such as white sugar, brown sugar and honey, mustard, salt, pepper, hot chili sauce, vinegar, smoked mesquite seasoning, and commercial sweet barbeque sauce mixed in specific proportions.

A provisional application No. 61/146,341, describing the present invention was filed Jan. 22, 2009.

### FIELD OF THE INVENTION

The present invention relates to a food preparation product and in particular to a novel barbecue sauce having a unique taste for flavoring various food products.

### BACKGROUND

Sauces are well known for flavoring a wide variety of food products. Typically, sauces are used for marinating and cooking meats. This is universally true when grilling or barbequing meat over an open flame where the sauce is seared into the meat giving it a distinct flavor depending upon the particular ingredients used in the sauce. Hence the generic name barbecue sauce. Many varieties are commercially available to satisfy the tastes of the ultimate consumers.

The prior patent art has recognized attempts to create a distinctive sauce of this type. For example, U.S. Pat. No. 6,869,634 discloses a barbecue sauce made from a mixture of vinegar, lemon juice, sage, red pepper, paprika, black pepper, white pepper, Worcestershire sauce, steak sauce, margarine, brown sugar, chili power, garlic salt, onion salt, seasoning salt, meat tenderizer, tomato sauce and ketchup.

U.S. Pat. No. 5,885,644 describes a sauce made with, nuts, vinegar, water, oil and salt.

U.S. Pat. No. 3,930,030 discloses a sauce with a tenderizing agent combined with tomato paste, sugar, gum oil, salt, spices, garnish preservative agents, vinegar and water.

In addition, there a number of recipes for barbecue sauce available from a wide variety of cook books and published material relating to food preparation. A search on the internet under the terms “barbecue sauce” reveals an additional number of mixtures of ingredients used as a barbecue sauce. For example a relevant site is online-cookbook.com. However none of these disclose the mixture of the present invention.

### SUMMARY OF THE INVENTION

The present invention is directed to a barbecue sauce having a unique taste that serves as a flavor enhancer for a number of prepared foods, particularly grilled and cooked meats. The sauce may be used during the cooking or grilling process and/or may be applied to meats already cooked to add a unique and flavorful taste to the food.

The barbeque sauce of the present invention is made with a combination of commonly available ingredients but which are mixed in a unique and flavorful combination suitable for marinating, basting, cooking or as a tasty spread for application to a wide variety of foods including but not limited to, beef, pork, chicken and similar foods. The ingredients include sweeteners such as white sugar, brown sugar and honey, as well as mustard, salt, pepper, hot chili sauce, vinegar, smoked mesquite seasoning, and commercial sweet barbeque sauce.

An object of the present invention is the provision of a unique tasting barbecue sauce for use in food preparation.

Another object of the invention is the provision of a barbecue sauce that is equally useful as a flavor enhancer while cooking foods such as meats and as a flavor enhancing coating for meats already cooked.

Still another object of the invention is the provision of a barbecue sauce that is easily prepared from readily available ingredients.

These and other objects will be apparent with reference to the following specification and accompanying claims.

### DETAILED DESCRIPTION OF A PREFERRED EMBODIMENT

An example of a typical mixture of the ingredients to prepare approximately one gallon of barbeque sauce uses the following ingredients in the following volume proportions. It will be appreciated that proportions given may vary slightly and still result in essentially the same sauce. Also smaller and/or larger volumes of the sauce can be prepared as long as the relative proportions of ingredients are followed. For example, the sauce may be made with one half of the amounts of ingredients listed below to provide a smaller batch of sauce. Similarly the sauce may be prepared in multiple amounts of ingredients listed below to provide larger batches as might be used in high volume restaurants or for bottling purposes for eventual sale to consumers.

2 cups brown sugar

3 cups honey

3-4 cups mustard

2 cups hot sauce

2 cups sweet commercial barbecue sauce

½ cup vinegar

4 tablespoons white sugar

3 tablespoons seasoned salt

3 tablespoons black pepper

3 tablespoons smoked mesquite seasoning

By volume the barbecue sauce is approximately 12 to 15% brown sugar, 20 to 25% honey, 25 to 30% mustard, 8 to 24% hot sauce depending upon the level of spicy flavor, 4% vinegar and 12 to 16% sweet commercial barbecue sauce. In addition there is less than 1% of each of the following ingredients; white sugar, seasoned salt, black pepper and smoked mesquite seasoning.

The barbeque sauce of the invention does not require cooking. To prepare the barbeque sauce it is preferable to first mix brown sugar and hot sauce. Next the commercial barbeque sauce, mustard, vinegar, and honey are mixed together with the brown sugar and hot sauce. Finally the white sugar, salt, pepper, and mesquite seasoning are added and blended until all the ingredients are smooth.

The sauce may be made spicy or mild by varying the amount of hot sauce. A mild sauce will use 1 to 1½ cups hot sauce whereas a spicy sauce will use up to 3 cups hot sauce.

It will be appreciated that the above example is representative of the invention but various modifications may be made in keeping with the spirit and scope of the invention as defined in the following claims. For example other sweeteners such as molasses may be used in place of the honey and/or sugar. The amounts of the ingredients may be varied in order to make lesser or larger batches of the sauce as long as the relative proportions are maintained. Also a variety of commercial barbecue sauces may be employed in preparing the sauce of the present invention.

1. A process for making a barbecue sauce comprising the steps of:
preparing a first mixture of ingredients including a sweetener and hot sauce;
preparing a mixture of second ingredients including barbecue sauce, mustard, vinegar, and honey and blending said combination of second ingredients with said first mixture of sweetener and hot sauce; and; preparing a mixture of third ingredients including salt, pepper and mesquite seasoning and blending said mixture of third ingredients with said blended first mixture and said second mixture of ingredients.

2. The process of claim 1 wherein said sweetener is defined as consisting of brown sugar and honey.

3. The process of claim 1 further including the step of adding white sugar to the combination of third ingredients.

4. A barbecue sauce product having a combination of ingredients comprising: sweeteners including white sugar, brown sugar and honey, mustard, seasoned salt, black pepper, hot chili sauce, vinegar, smoked mesquite seasoning, and sweet barbeque sauce; said ingredients being defined by volume ranges of approximately 12 to 15% brown sugar, 20 to 25% honey, 25 to 30% mustard, 8 to 24% hot sauce, 4% vinegar, 12 to 16% sweet commercial barbecue sauce and less than 1% of each of the following ingredients; white sugar, seasoned salt, black pepper and smoked mesquite seasoning.

5. A barbecue sauce having a combination of ingredients; said ingredients being mixed in proportions relative to the amounts as defined hereinbelow consisting of:
2 cups brown sugar; 3 cups honey; 3-4 cups mustard;
2 cups hot sauce;
2 cups sweet commercial barbecue sauce; ½ cup vinegar;
4 tablespoons white sugar; 3 tablespoons seasoned salt;
3 tablespoons black pepper; and
3 tablespoons smoked mesquite seasoning.

6. The barbecue sauce of claim 4 wherein the level of spiciness is controlled by regulating the amount of hot sauce.

7. The barbecue sauce of claim 4 being further defined as being made by the process of claim 1.
